(19) United States
(12) Patent Application Publication
(10) Pub. No.: US 2006/0013587 A1
(43) Pub. Date: Jan. 19, 2006

(54) Modular wavelength selective switch

(76) Inventors: Kenneth Gordon Scott, Kanata (CA); Thomas Ducellier, Ottawa (CA); Alan Hnatiw, Stittsville (CA); Doug Ranahan, Ottawa (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 11/181,701

(22) Filed: Jul. 15, 2005

Related U.S. Application Data
(60) Provisional application No. 60/587,906, filed on Jul. 15, 2004.

(51) Int. Cl. H04J 14/02

(52) U.S. Cl. 398/83

(57) ABSTRACT

Modular WSS (wavelength selective switch) designs are provided that allow a WSS to be built out for a first set of wavelengths, with the capacity for later expansion to handle a second set of wavelengths with minimal impact on the operation of the system for the first set of wavelengths. An optical signal separator separates each incoming signal into the two bands, and at each output, the bands are then re-combined. In between, wavelength selective switching is performed separately for each of the two bands, or initially only for one of the bands, with later upgradability to switch the second band.

### RELATED APPLICATION

This application claims the benefit of U.S. Provisional Application No. 60/587,906 filed on Jul. 15, 2004.

### FIELD OF THE INVENTION

The invention relates to wavelength selective switches.

### BACKGROUND OF THE INVENTION

Wavelength selective switches operate to separate multiple wavelengths contained in an input signal, and to route each of these wavelengths to a selectable port. Typically, such switches have a fixed number of output ports, and are capable of operating on a fixed number of wavelengths. Conventional designs are not scalable meaning that once the port and/or wavelength capacity of a given wavelength selective switch is exhausted, then in order to provide increased capacity the switch will need to be replaced with a larger model.

### SUMMARY OF THE INVENTION

According to one broad aspect, the invention provides an apparatus comprising: at least one first input port each for receiving a respective input multiple wavelength optical signal; for each first input port, an optical signal separator adapted to separate the input optical signal into at least two portions, and to output each portion to a respective first output port; at least one second output port for outputting a respective output optical signal; for each second output port, an optical signal combiner having at least two second input ports, the optical signal combiner adapted to combine optical signals received at the at least two second input ports; at least one reconfigurable wavelength selective device, each wavelength selective device interconnecting wavelength selectively one of the first output ports to at least one of the second input ports.

According to another broad aspect, the invention provides an apparatus comprising: a full-band drop device having an input port, a through port and a first plurality of drop ports; a full-band add device having an input port connected to the through port of the full-band device, and having a first plurality of add ports; a reduced-band drop device having a second plurality of drop ports, and having an input port connected to one of said first plurality of drop ports; a reduced-band add device having a second plurality of add ports and having an output port connected to one of said first plurality of add devices.

According to another broad aspect, the invention provides an apparatus comprising: a first main optical path comprising a first wavelength adding device having a first plurality of add ports and a first wavelength dropping device having a first plurality of drop ports; a second main optical path comprising a second wavelength adding device having a second plurality of add ports and a second wavelength dropping device having a second plurality of drop ports; for each of pair of drop ports comprising one port of each of said pluralities of drop ports, a respective optical signal combiner combining outputs of the pair of drop ports into a combined drop port signal; for each pair of add ports comprising one port of each of said pluralities of add ports, at least one optical separator separating an input signal to the two add ports.

According to another broad aspect, the invention provides an apparatus comprising: a plurality M of port pairs each comprising an input port and an output port; for each input port, an optical signal separator splitting an input optical signal into at least two portions; for each output port, an optical signal combiner for combining optical signals received at inputs to the optical signal combiner; a plurality of interconnections and wavelength selective switches between outputs of optical signal separators and inputs of the optical signal combiners.

According to another broad aspect, the invention provides a method comprising: receiving at least one input multiple wavelength optical signal; for each input multiple wavelength optical signal, separating the input optical signal into at least two portions; outputting at least one output optical signal as a combination of at least two optical signals; wavelength selectively switching at least one of the portions to produce at least one of the optical signals to be combined in the output optical signals.

In some embodiments, each non-overlapping subset of wavelengths is a contiguous subset of an overall set of wavelengths.

In some embodiments, the WSS function is performed for one of said portions.

In some embodiments, the WSS function is performed individually for at least two of said portions.

In some embodiments, for at least input optical signal, output optical signal pair: the portions comprise non-overlapping sets of wavelengths, when present, in the input multiple wavelength optical signal; wavelength selectively switching comprises performing a wavelength adding function and/or a wavelength dropping function on at least one of the portions; wherein each portion is passed either directly or via said wavelength adding function and/or wavelength dropping function as a respective one of the optical signals to be combined to produce the output optical signal.

In some embodiments, for at least input optical signal, output optical signal pair: each non-overlapping set of wavelengths is a contiguous subset of an overall set of wavelengths.

In some embodiments, at least two of the portions are passed via respective wavelength adding functions and/or wavelength dropping functions.

In some embodiments, the method further comprises: combining an output of the wavelength dropping function of two optical interconnections into a combined drop signal.

In some embodiments, the method further comprises: separating an input signal to respective inputs of two of said add functions.

In some embodiments, the method further comprises: combining an output of two of the wavelength dropping device of two optical interconnections into a combined drop signal; separating an input signal into inputs of two of said wavelength adding functions.

In some embodiments, the method further comprises inputting a tunable laser output as said input signal.

In some embodiments, separating comprises optical interleaving, and combining comprises optical de-interleaving.

According to another broad aspect, the invention provides a method comprising: defining a plurality M of port pairs each comprising an input port and an output port; for each input port, separating an input optical signal into at least two portions; for each output port, combining signals received for outputting at the output port; interconnecting and wavelength selectively switching the portions to the output ports.

In some embodiments, separating comprises band de-multiplexing.

In some embodiments, separating comprises signal splitting.

In some embodiments, interconnecting and wavelength selectively switching the portions to the output ports comprises: implementing a degree N cross connect in at least one of the portions, where N<=M.

In some embodiments, interconnecting and wavelength selectively switching the portions to the output ports comprises: implementing a degree N′ cross connect in another of the portions, where N′<=M.

### BRIEF DESCRIPTION OF THE DRAWINGS

Preferred embodiments of the invention will now be described with reference to the attached drawings in which:

FIG. 1 is a block diagram of a modular wavelength selective switch provided by an embodiment of the invention;

FIG. 2A is a block diagram of a half-band device provided by an embodiment of the invention with a through path and an add/drop path;

FIG. 2B is a block diagram of a half-band device provided by an embodiment of the invention featuring add/drop capability on each of two paths;

FIG. 3A is a block diagram of a half-band device provided by an embodiment of the invention keeping any-to-any connectivity on some ports using optical signal combiners;

FIG. 3B is a block diagram of a half-band device keeping any-to-any connectivity on some ports using band multiplexers;

FIG. 4 is a hybrid configuration with add/drop capability on band A and B and all-optical wavelength cross-connect on band B;

FIG. 5 is a block diagram of an add/drop arrangement featuring tunable drop ports and passive add ports;

FIG. 6 is a block diagram of a reconfigurable add/drop multiplexer featuring additional upgrade ports serviced by half-band devices;

FIG. 7 is a block diagram illustrating the use of half-band devices for east/west traffic and full-band tunability on transponders for steerability;

FIG. 8A is a block diagram of an interleaved device provided by an embodiment of the invention;

FIG. 8B is a block diagram of an interleaved device featuring tunable interleavers as provided by an embodiment of the invention;

FIGS. 9A and 9B show the integration of a tunable interleaver on a photonic lightwave circuit (PLC);

FIG. 10 is a block diagram of a modular WSS apparatus featuring passive combiners and splitters;

FIGS. 11 and 12 are block diagrams of a modular degree 4 wavelength cross connect;

FIG. 13 is a block diagram of the degree 4 wavelength cross connect in Band A of FIG. 11 with added functionality for a degree 3 wavelength cross connect in Band B;

FIG. 14 is a block diagram of the wavelength cross connect in Band A of FIG. 11 with added through paths for Band B;

FIG. 15 is a block diagram of another arrangement for connecting outputs and inputs of optical signal separators and optical signal combiners such as the fixed band multiplexers and demultiplexers of FIG. 14; and

FIG. 16 is a block diagram of another embodiment of the invention.

### DETAILED DESCRIPTION OF THE PREFERRED EMBODIMENTS

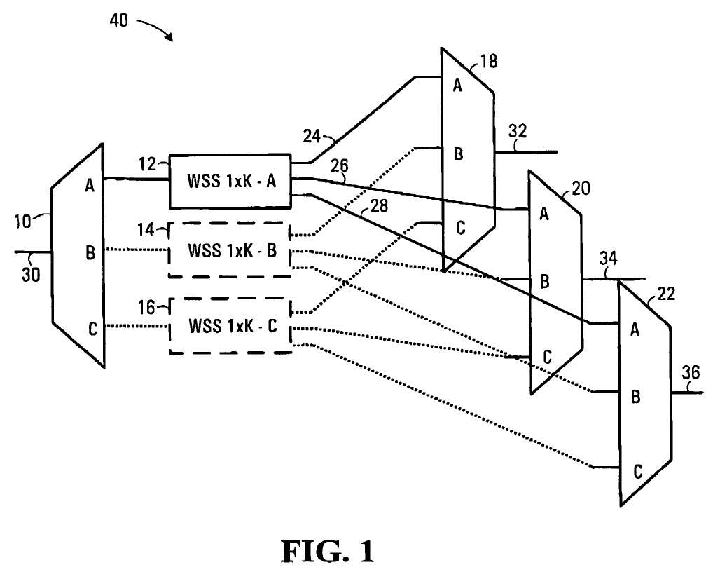

A first embodiment of the invention will now be described with reference to FIG. 1 which shows a modular wavelength selective switch generally indicated at 40. The switch features an input port 30 and a plurality of output ports 32, 34, 36. The illustrated example shows three output ports, but any number of ports can be employed. The input port 30 is connected to a first fixed wavelength selective device 10 that is responsible for routing subsets of wavelengths received through the input port to a set of output ports of the wavelength selective device 10. In the illustrated example, it is assumed that there are three such output ports that output subsets labelled A, B and C. In some embodiments, the wavelengths of a given subset are contiguous. The wavelengths of Group A then pass through a 1×K wavelength selective switch 12. WSS 12 routes each wavelength it receives to a selectable output port of K output ports. In this drawing, three such output ports are shown but any other number of ports can be employed. Preferably, WSS 12 has an output port for each output of the modular WSS. More particularly, it has an output 24 associated with output 32; an output 26 which is associated with output 34; and output 28 which is associated with output 36. Output 24 of WSS 12 is connected to an input of another fixed wavelength selective device 18. Device 18 has a number of inputs equal to the number of outputs of device 10. Device 18 performs a combining function upon the inputs to produce the overall output at 32. In the absence of connections to WSS 14 and WSS 16, described below, device 18 only has a single input. Similarly, the second output 26 is connected to a port of fixed wavelength selective device 20 which produces overall output 34 and output 28 is connected to fixed wavelength selective device 22 which produces overall output 36.

In operation, in the absence of wavelength selective switches 14, 16 described below, wavelengths of subset A are routed by fixed wavelength selective device 10 from the input port 30 to wavelength selective switch 12. Wavelength selective switch 12 performs a wavelength switching function switching any one of the input wavelengths to one of the output ports 24, 26, 28. In the illustrated example, any wavelength can be routed selectively to any of the three output ports 24, 26, 28. Then the fixed wavelength selective device 18 performs a combining function on signals received on its three input ports to produce the output signal at 32. However, in the absence of WSS 14 and WSS 16, there would only be the signal from WSS 12. The wavelengths selectively routed to output 26, 28 also appear at outputs 34, 36 in a similar manner. In summary, it can be seen that the effect of the arrangement is to enable the routing of any of the wavelengths of subset A from the input port 30 to any selected output port 32, 34, 36.

The arrangement of FIG. 1 is now scalable to allow additional wavelength routing. In particular, a second WSS 14 can be installed as shown in FIG. 1. Advantageously, in some implementations this may be able to be done without interrupting traffic on wavelengths of subset A. The second WSS 14 is connected to receive the wavelengths of subset B from the input fixed wavelength selective device 10, and to perform a wavelength selective function upon these wavelengths to route any wavelength of Group B to any output port of device 14. The output ports of WSS 14 are then connected to respective input ports of the fixed wavelength selective devices 18, 20, 22. Now, with the inclusion of wavelength selective switch 14, any wavelength in subset B that appears at the input 30 is selectively routable to any output port 32, 34, 36. In other words, the operable bandwidth of the overall device has increased with the addition of the second WSS 14. Similarly, WSS 16 can be added to perform wavelength selective switching between any wavelength of subset C in the input to any selected output port 32, 34, 36.

Input fixed wavelength selective device 10 is any device capable of performing the desired function of dividing the input wavelength set into the appropriate subsets. Examples of appropriate devices include a band demultiplexer or an optical interleaver. The wavelength selective switch in the illustrated example takes a single input and routes wavelengths to any output port of the device. More generally, the switch may have multiple inputs and multiple outputs.

The fixed wavelength selective output elements 18, 20, 22 at the output are any devices capable of performing the required combination of signals on the three input ports to provide the overall output. In some implementations, they are passive combiners. In other implementations they are wavelength selective devices. Examples of appropriate devices include a band multiplexer or optical de-interleaver. In the illustrated example, the first WSS 12 routes any one of the A wavelengths to any one of three output ports. The inclusion of a second WSS enables the routing of any one of the B wavelengths to any one of three output ports. Finally, the further inclusion of WSS 16 enables the routing of any one of the C wavelengths to any one of three outputs, effectively increasing the number of wavelengths that the modular WSS 40 can switch.

In the embodiment of FIG. 1, there is wavelength selectivity on all three paths containing the wavelengths of Groups A, B and C. In another embodiment, at least one of these paths is simply a through path. For example, it may be that all of the wavelengths of subset B are to be routed to a predetermined output port 32, 34 or 36. In such an implementation, the output B of the fixed input wavelength selective device 10 would simply be connected directly to an appropriate port of one of the output fixed wavelength selective devices 18, 20 or 22 such that all of the light in any of the wavelengths of Group B are routed to the appropriate overall output port.

In another embodiment, any or all of fixed wavelength selective devices 10, 18, 20 or 22 are replaced by configurable wavelength selective devices, such as thin film filters and electro mechanical switches or Fiber Bragg grating thermally tuned.

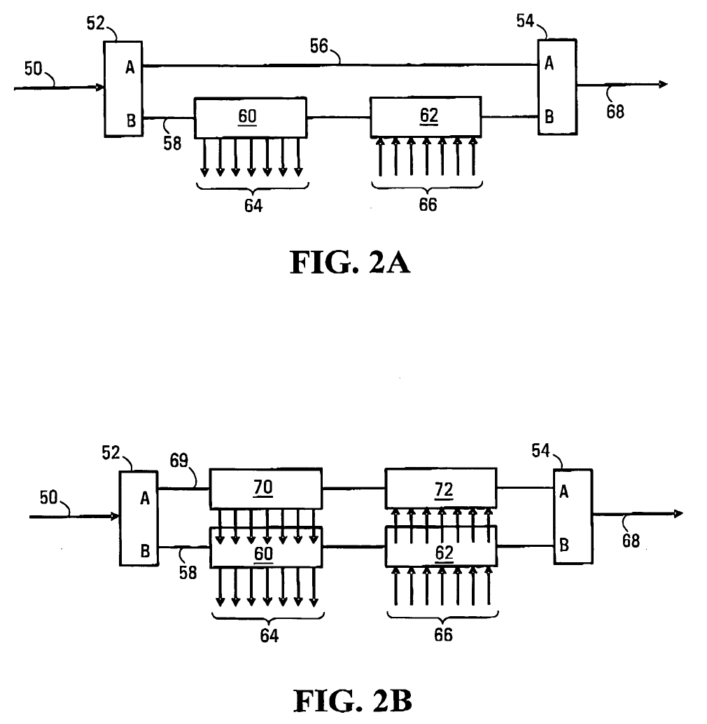

In another embodiment, rather than using a wavelength selective switch in each band, various permutations of add/drop multiplexers are employed. Several examples of this will now be described with reference to FIGS. 2 through 9.

In some embodiments, the WSSs that are used to switch bands A, B and C (or more generally whatever number of bands are present) are cyclical WSS. Cyclical means that the same WSS can be configured to switch {λ₁, λ₂, λ₃ . . . }, or {λₙ₊₁, λₙ₊₂, λₙ₊₃ . . . }, or {λ₂ₙ₊₁, λ₂ₙ₊₂, λ₂ₙ₊₃ . . . } and so on. The same WSS can be used to work on subsets A, B and C if they happen to be cyclical bands (A=1 to n, B-n+1 to 2n, C=2n+1 to 3n)

Referring now to FIG. 2A, shown is an embodiment of the invention featuring two paths 56, 58 between an input port 50 and output port 68. Input wavelength selective device 52 divides an overall band of wavelengths into subsets A and B such that subset A goes on path 56 and subset B goes on path 58. Output device 54 combines the signals on the two paths to produce the output 68. In the illustrated example, 56 is a through path meaning that any wavelength in subset A simply passes through the device directly from the input port 50 to the output port 68. On path 58 there is add/drop functionality. There is a drop device 60 having a plurality of drop ports 64 through which wavelengths of subset B can be dropped. There is also an add device 62 with add ports 66 through which wavelengths of subset B can be added. In this manner, the add device 60 and the drop device 62 can be implemented to only allow adding and dropping on wavelengths belonging to subset B.

In a preferred embodiment, subset A and subset B are one half of an overall wavelength band to be processed by the device. Thus, half of the wavelengths go directly through and half of the wavelengths are subject to adding and dropping.

In another embodiment, shown in FIG. 2B, rather than having through path 56, path 69 between the input wavelength selective device 52 and the output device 54 is provided, and there is an drop device 70 and an add device 72 similar to path 58. In this case, adding and dropping for wavelengths of subset A can also be performed. However, it can be seen that there is not full flexibility on the adding and dropping ports. In particular, a wavelength of subset A cannot be dropped to the same port as a wavelength of subset B, and a wavelength of subset A cannot be added from the same port as a wavelength from subset B. This is because separate ports are provided for the adding and dropping within these different subsets.

In another embodiment, additional paths between the input device 52 and the output device 54 are provided each with their own respective either through capability or add and/or drop capability. This embodiment is modular in the sense that an initial implementation might only include one path with add/drop capability. This is scalable in include the add/drop capability on other paths.

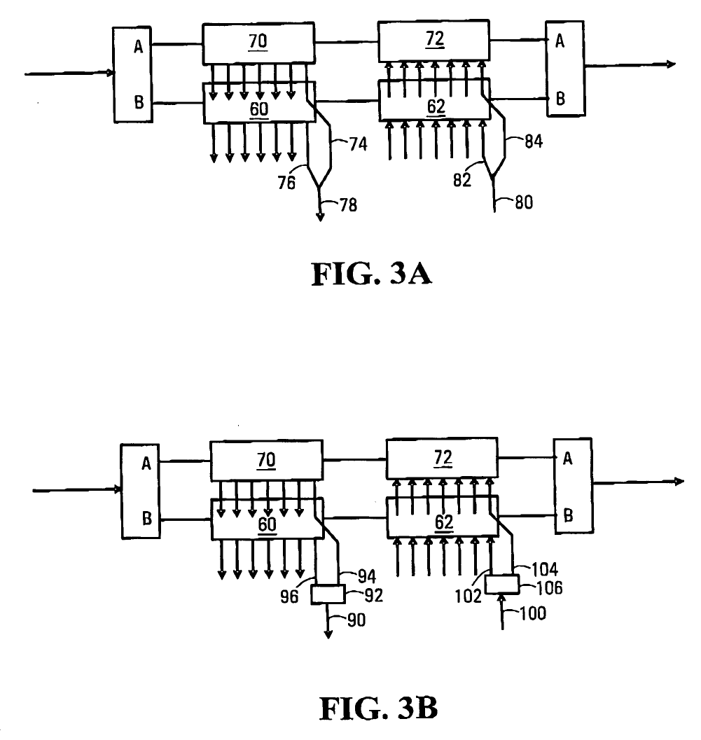

Referring now to FIG. 3A, an embodiment of a half-band device is shown which is similar to that of FIG. 2B. However, in this case the drop ports of drop devices 70, 60 are passively combined for at least one port. In particular, for ports 74, 76 these are combined to produce output 78. Preferably such a combination is done for each pair of ports on the two drop devices 70, 60. In this manner, any wavelength of input band A or B can be routed to any of the combined drop ports. Similarly, on the add port side the add ports of devices 62, 72 can also be tied together such that the add ports behave as a single port. In the illustrated example, port 80 is shown connected to both input ports 82, 84 of add devices 62, 72. Preferably, such a port splitting is conducted for each of a set of input ports that are then connected to both add devices 72, 62.

FIG. 3B is similar to the embodiment of FIG. 3A with the exception of the fact that rather than using passive combiners and splitters, band multiplexers are employed to keep the any-to-any connectivity enabling lower insertion losses than passive combiners/splitters. Thus, in the illustrated example a band multiplexer 92 is shown combining outputs of ports 94, 96 of drop devices 70, 60. Similarly, band multiplexer 106 is shown splitting an input port 100 to ports 102, 104 of add devices 62, 72.

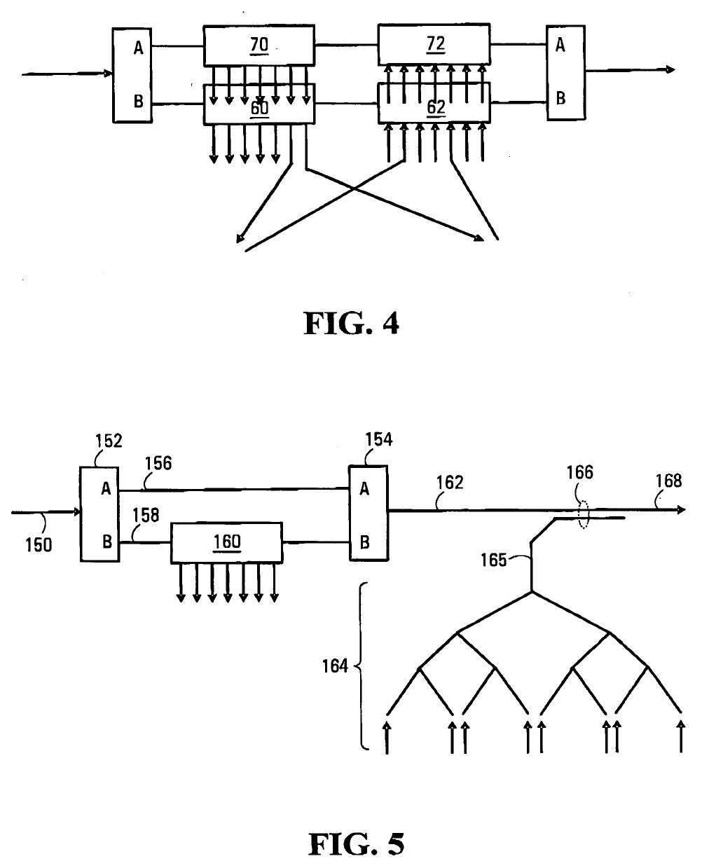

FIG. 4 shows another embodiment of the invention in which wavelengths of subset A can be added or dropped, while wavelengths of subset B can be added, dropped, or all-optically switched.

FIG. 5 shows another embodiment of the invention in which input wavelengths received at input 150 are again split into two different subsets A and B by input device 152. The two bands pass along paths 156, 158. Path 156 is a through path directly to output device 154 which again performs a combining operation on the two paths. Path 158 passes through drop device 160 which allows one or more of the wavelengths of the subset B to be dropped. The output of device 154 is indicated at 162. Passive adding is then performed by passive combination elements 164 which produce an add signal 165 which is combined with output signal 162 at 166 to produce overall output 168. While a particular arrangement of add functionality 164 is shown to allow the addition of eight wavelengths, any appropriate passive add circuitry can alternatively be employed to add fewer or a larger number of wavelengths.

To increase capacity in the device of FIG. 5, a drop device capable of processing wavelengths of subset A is inserted on path 156. No change is required on add device 164. Preferably, drop ports from devices on path 156 and 158 are combined using combiners or band multiplexers.

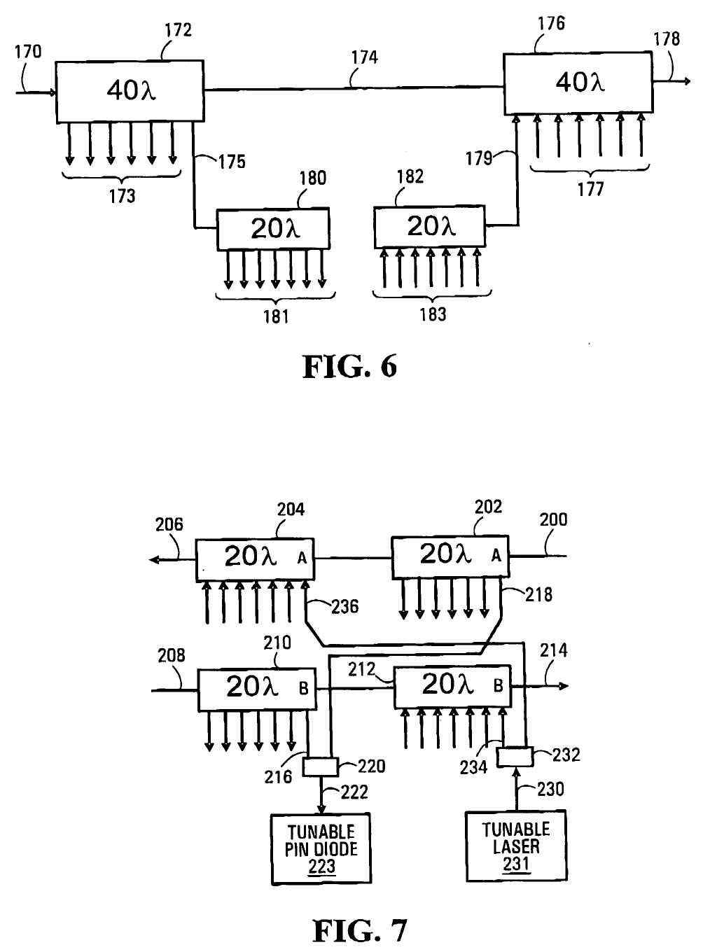

Referring now to FIG. 6, another embodiment of the invention features the use of half-band devices to provide upgrade ports for full-band devices. In the illustrated example, there is a main input port 170 connected to a full-band drop device 172. The drop ports of device 172 include ports 173 and 175. In order to expand the capacity of the device, drop port 175 is shown connected through to an additional half-band device 180 which performs additional wavelength dropping and has additional ports 181. Thus, the overall drop ports of the combined devices 172, 180 are ports 173, 181. Similarly, on the add side full-band device 176 has input add ports 177, 179. However, half-band device 182 is shown connected to input port 179 so that additional input ports 183 are provided. Thus, the arrangement effectively has add ports 183 plus 177. Wavelengths not dropped by the drop device 172 are passed along 174 to the add device 176 and on to the output 178. The arrangement of FIG. 6 does result in some moderate inflexibility of port assignments because drop ports 181 and add ports 183 can only operate on half-band, while drop ports 173 and add ports 177 can operate on the full-band. Preferably, the additional half-band devices cover another set of wavelengths from half-band devices 180, 182. Furthermore, it can be seen that additional half-band devices can be added similar to devices 180, 182 to provide additional ports. In the illustrated example, the “full-band” device has 40λ capacity, and the “half-band” device has 20λ capacity. This is simply an example. In fact, the expansion devices 180, 182 can have any number of wavelengths as can the main devices 172, 176, and the number of wavelengths of devices 180, 182 and devices 172, 176 need not be related by the particular 1:2 ratio of the example.

FIG. 7 is another system diagram showing the use of half-band devices for east/west traffic and full-band tunability on transponders for steerability. West traffic enters the arrangement at 200 and leaves at 206, and east traffic enters 208 and leaves at 214. West traffic passes through drop device 202 and add device 204. Similarly, east traffic passes through drop device 210 and add device 212. Wavelengths can be added to either the east traffic or the west traffic through input ports in the add devices 212, 204. Preferably, the ports are connected together. For example, a first input port 230 is shown connected to respective input ports 234, 236 on add device 212 and add device 204. A band multiplexer 232 sends the wavelengths to the appropriate device. Similarly, output port 222 can receive dropped wavelengths from port 216 of drop device 210 or port 218 of drop device 202. In the illustrated example, west traffic is on the A band while east traffic is on the B band. Preferably each of the drop ports are tied together in a similar manner to that shown for output port 222 and each of the add ports are tied together in a similar manner to that shown for add port 230. In operation, a tunable transponder such as a laser can be connected to add port 230 and/or drop port 222 to provide for east/west steerability. Tuning the transponder to any wavelength of band A would enable west communication, while tuning to any wavelengths of the band B would then enable east communication. The transponder might be a tunable laser 231 for add ports or a tunable PIN diode 223 for drop ports. It can be seen that the arrangement of FIG. 7 can be extended to additional bands.

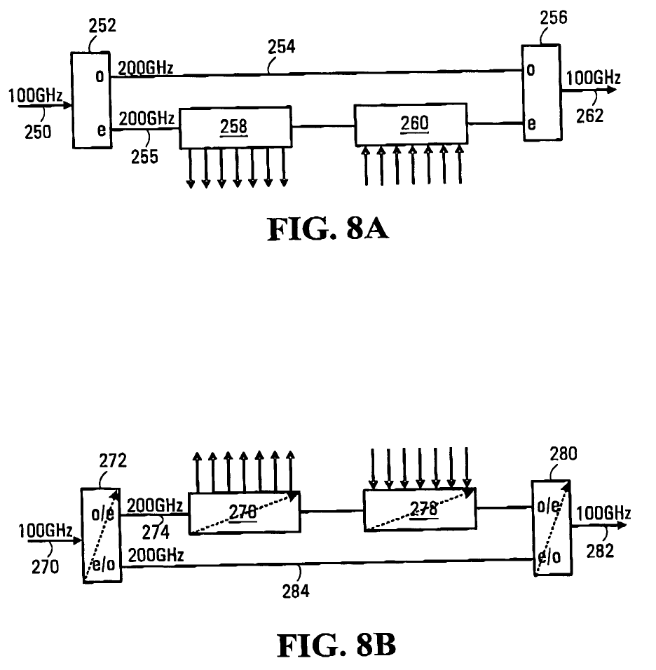

Referring now to FIG. 8A, in another embodiment of the invention, rather than dividing an input signal into two contiguous bands, an interleaver is provided at the input to divide the channels into even and odd channels. In the illustrated example, input port 250 is connected to interleaver 252 which outputs odd channels on through path 254 and outputs even channels on path 255. Of course the even and odd ports could be switched to allow the even ports to be the through path. Add functionalities are provided with add device 260 for even ports only, and drop functionalities provided with drop device 258 for even ports only. At the output, device 256 combines the even channels and the odd channels to produce overall output signal 262.

In the embodiment of FIG. 8B, structurally this looks similar to the embodiment of FIG. 8A, but in this case there is an interleaver 272 capable of switching between routing the even ports to output path 274 and the odd ports to output path 284 and alternatively sending the odd ports to output path 274 and the even ports to output path 284. For path 274, there is a drop device 276 which is tunable to allow dropping of odd channels or even channels. There is also an add device 278 which is tunable to allow adding of odd channels or even channels. Finally, the output device 280 is also tunable to perform the appropriate combination of channels received from path 274 and 284 to produce overall output signal 282. In one embodiment of the invention, device 280 is simply a passive combiner.

For the embodiments of FIGS. 8A and 8B, the channel spacing on the two paths is double that on the input and output signals. Thus, in the illustrated example with a 100 GHz channel spacing on the input port and the output port, the two paths connecting input and output devices 252, 256 have channel spacing 200 GHz. Other channel spacings are possible.

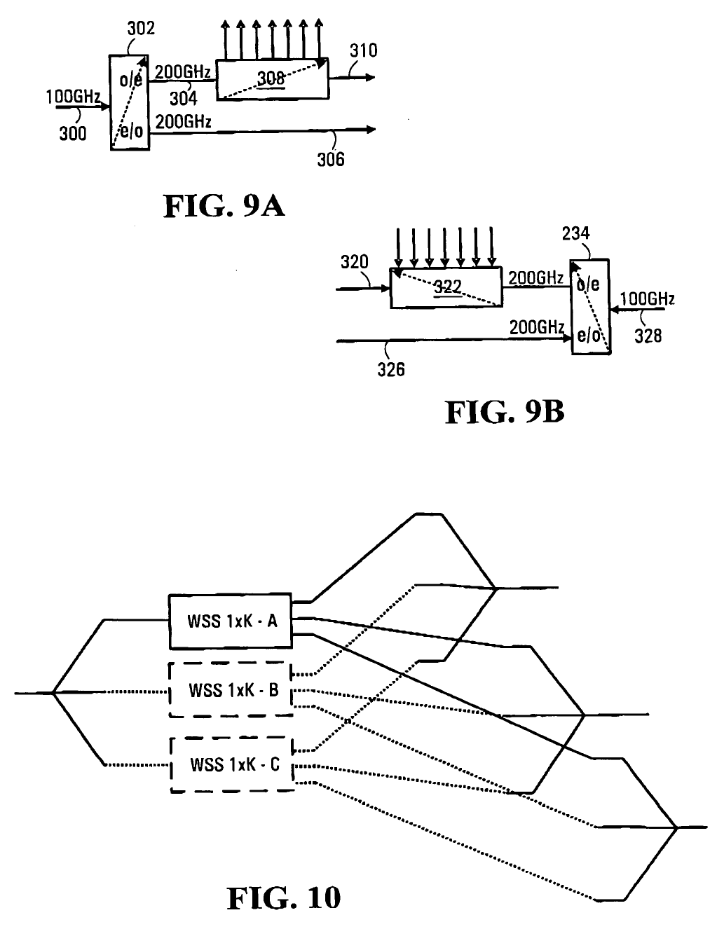

FIG. 9A and 9B describe a tunable integrated bi-directional interleaver-WSS. The same device can be used either for a drop configuration (FIG. 9A) or an add configuration (FIG. 9B). In the case of WSS realized with parts in waveguide technology, the interleaver can advantageously also be realized in waveguide technology and be integrated on the same substrate with parts of the WSS for compactness.

Another embodiment provided by the invention is similar to the embodiment described in detail above with reference to FIG. 1. However, in this embodiment, passive combiners and splitters are used in place of the band demultiplexers and/or band multiplexers of FIG. 1. An example of this is shown in FIG. 10. Preferably, each WSS 1×K A, B or C blocks all other wavelengths but the ones that correspond to respective bands A, B or C. It is therefore an integrated WSS and band blocker. If not, multiple copies of the same wavelengths would go through the arrangement. This arrangement scales to any number of inputs, and passive devices can be used in other embodiments as well.

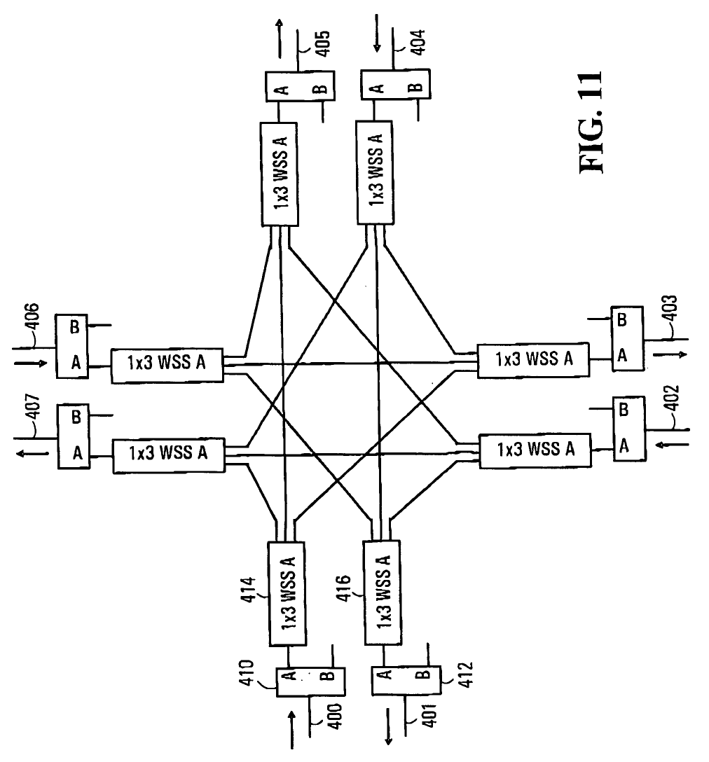

Another embodiment of the invention provides a modular degree N WXC (wavelength cross connect) using modular WSS. A particular example is shown in FIG. 11 which is a degree 4 example. There are four pairs of input and output ports 400, 401; 402, 403; 404, 405; and 406, 407. The details of the first pair 400, 401 will be described, the other pairs being similar.

The input port 400 is input to a band demultiplexer 410 which separates a signal on the input port into two signals having non-overlapping wavelength subsets, preferably contiguous sets. In the illustrated example, these are referred to as Band A and Band B. Band A is routed to an input 1×3 WSS Band A device 414 which performs wavelength switching on wavelengths in Band A. In the illustrated example, nothing is connected to the Band B output of demultiplexer 410.

Similarly, the output port 401 is connected to a band multiplexer 412 which combines signals received on Bands A and B. In the illustrated example, there is nothing connected to the Band B input of multiplexer 412. The Band A input to multiplexer 412 is received from an output 1×3 WSS Band A device 416.

The output ports of the input 1×3 WSS Band A device 414 are each connected to a respective input of an output 1×3 WSS Band A device of another pair of ports thereby enabling any wavelength received on input port 400 to be routed to any of the output ports 403, 405, 407.

Similarly, the input ports of the output 1×3 WSS Band A device 416 are connected to a respective output port of an input 1×3 WSS Band A device of each other input port 402, 404, 406. Therefore, a wavelength received on any input port 402, 404, 406 can be selectively routed to the output port 401.

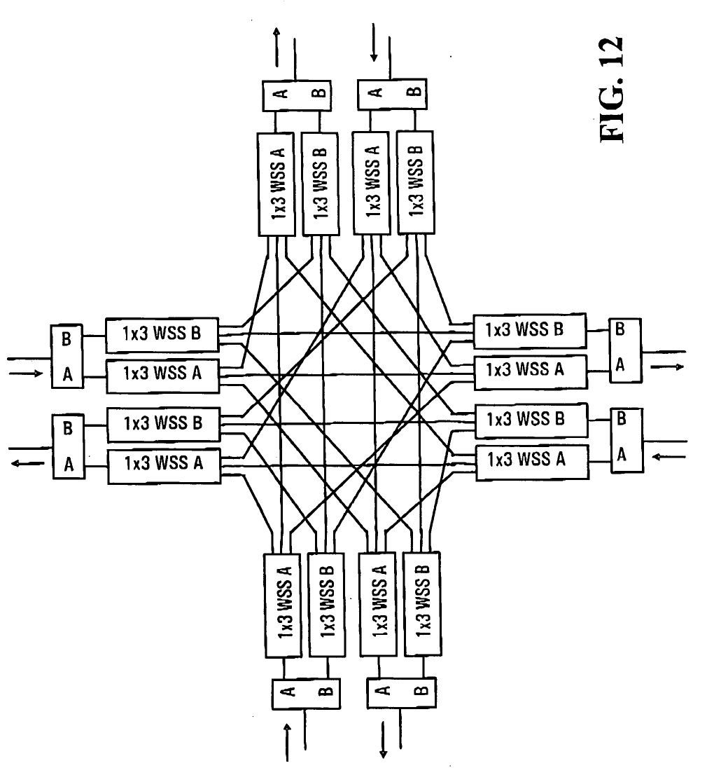

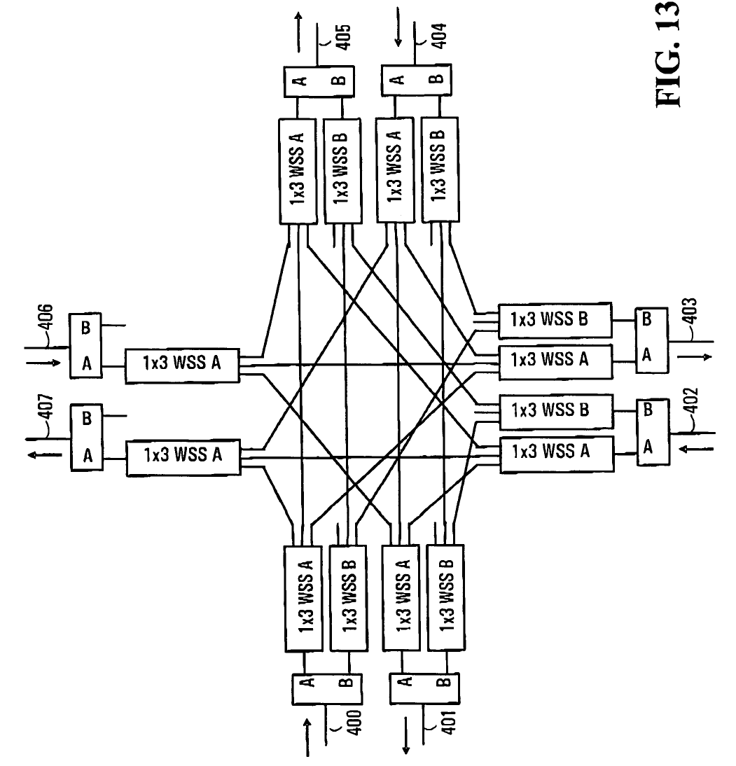

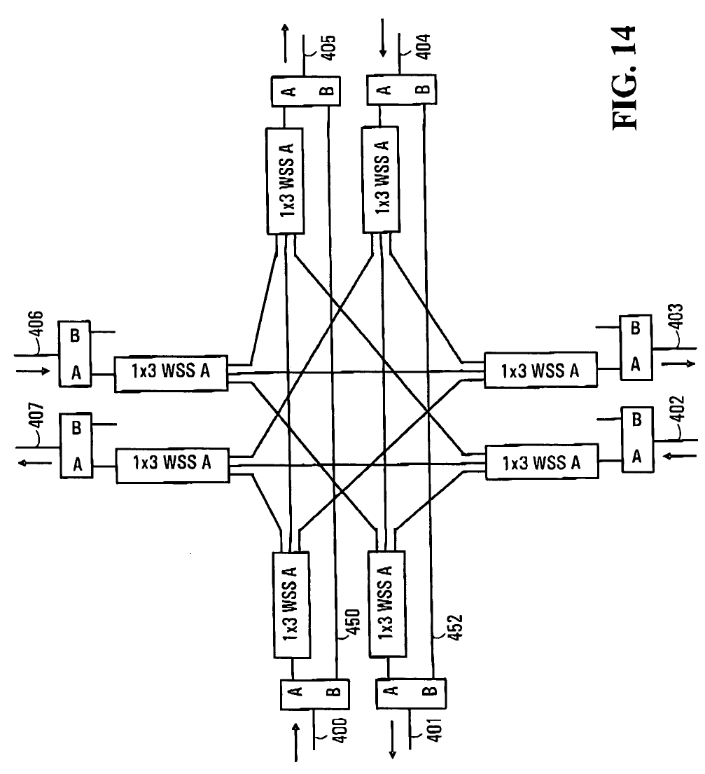

The functionality shown is only capable of switching wavelengths of Band A. However, the configuration is modular in the sense that 1×3 WSS Band B devices can now be added after the fact, and connected to the Band B inputs and outputs of the band multiplexers and band demultiplexers, and connected to each other, in a similar manner to the Band A functionality described above. After these additions, the full band A+B arrangement would appear as shown in FIG. 12. It is to be understood that the arrangement of FIGS. 11 and 12, and the embodiments of FIGS. 13, 14 described below is particular to the 4 degree case and that the concept easily extends to other degrees.

In the embodiment of FIG. 12, the additional functionality has been added to provide full degree 4 cross connect functionality for Band B. Alternatively, the degrees implemented on the different bands may be different. For example, when the functionality for Band B is built out, a degree 3 cross connect may be implemented. An example of this is shown in FIG. 13. FIG. 13 is similar to FIG. 12, but there is no Band B functionality for ports 406, 407. Rather, the cross connect for Band B is between port pairs 400, 401; 402, 403; and 404, 405. It can be seen the degree of the Band B functionality does not need to be decided upon until it is time to install the Band B equipment. This is because each port pair is equipped with the demultiplexing and multiplexing hardware. Alternatively, certain port pairs may be implemented without this functionality in which case it will not be possible to expand the functionality of those ports without adding this, For example for the embodiment shown in FIG. 13, the band demultiplexer and multiplexer connected to ports 406, 407 is not necessary if it is known that these ports will never need to handle Band B.

In another embodiment, degree N cross connect functionality is provided on one band, and pass through connections are provided on another band. An example of this is shown in FIG. 14. This arrangement is again similar at first to the arrangement of FIG. 11. However, in this case a first passthrough connection 450 is provided between ports 400, 405 and a second passthrough connection 452 is provided between ports 404, 401. It can be seen that with the arrangement of FIG. 11, passthrough connections between any Band B ports may be added.

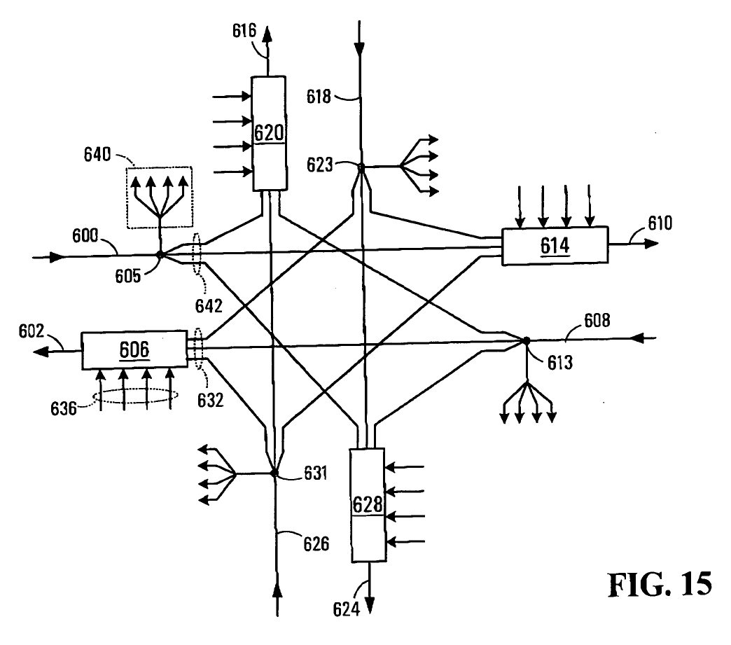

FIG. 15 shows another example of how input and output port pairs might be interconnected. Shown are four input ports 600, 608, 618, 626 and four output ports 602, 616, 610, 624. Each of the output ports has an associated wavelength selective switch 606, 620, 614, 628 each with an optional set of add ports, one such set being labeled at 636 for switch 606. For the input ports, each input port has a respective passive splitter 605, 623, 613, 631 that passively splits the input signal into multiple paths. The combination of a passive splitter on the input ports and wavelength selective devices on the output ports enables a unique wavelength routing function to be achieved. Also shown is an optional set of passive drops 640 connected to passive splitter 605. Such a set of passive drops might be included for any of the input ports. The wavelength selective switches and passive splitters are then interconnected in a manner similar to that described above for FIG. 14. The entire arrangement of FIG. 14 can then be used to interconnect the band “A” inputs and outputs of the band multiplexers and band de-multiplexers such as shown in FIG. 14. The same or a different arrangement can then be used to interconnect the band “B” inputs and outputs. In some embodiments, the passive drops 640 can be instead implemented using a fixed de-multiplexer in which case a wavelength selective dropping function is implemented.

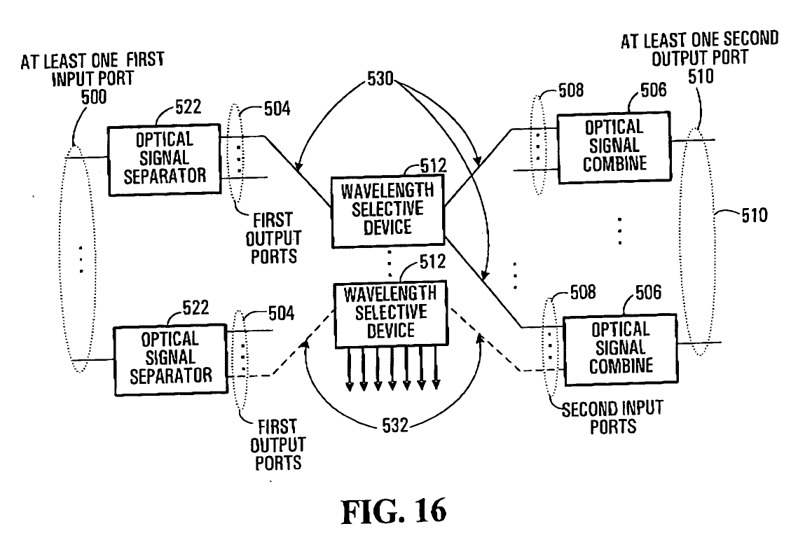

Referring now to FIG. 16 shown is a block diagram of another embodiment of the invention. This apparatus features at least one first input port 500. There is also at least one second output port 510. Each of the first input ports has a respective optical signal separator 522 that separates the incoming signal into a set of portions at the first output port 504. The optical signal separator might be a signal splitter in which case the portions are simply fractions of the power across the entire wavelength band of the input signal, or they might be fixed wavelength specific wavelength selective devices such as band de-multiplexers or optical interleavers in which case the signals that are output on the first output ports 504 are non-overlapping sets of wavelengths. At the output side, each output port 510 has a respective optical signal combiner 506 having a set of second input ports 508. The optical signal combiner 506 might be a passive combiner or a wavelength selective combiner such as a band multiplexer or de-interleaver.

Also shown is at least one wavelength selective device 512. Two are shown in the particular example illustrated. Each wavelength selective device 512 interconnects at least one of the first outputs to at least one of the second inputs in a wavelength selective manner meaning that particular wavelengths from the first output are routed to particular second input ports. Two particular interconnection examples are shown in the diagram. Interconnections 530 show one of the first output ports 504 wavelength selectively routed to a respective second input port on each of two optical signal combiners 506. In another example, generally indicated at 532 are interconnections for interconnecting a first output port to a single second input port, with the wavelength selected device also having a number of drop ports in that case. Note that the first example 530 is somewhat analogous to the block diagram of FIG. 1 described previously, and that the second example 532 is somewhat analogous to the example of FIG. 2A. However it can be easily seen how both of these systems can be implemented using the generic framework of FIG. 16, either on their own or simultaneously.

One of more of the wavelength selective devices may also feature wavelength adding capability. Furthermore, in some of the interconnections between the first output ports and the second input ports, there may be more than one wavelength selective device connected in series. An example of this can be seen in the FIG. 14 embodiment.

Numerous modifications and variations of the present invention are possible in light of the above teachings. It is therefore to be understood that within the scope of the appended claims, the invention may be practiced otherwise than as specifically described herein.

1. An apparatus comprising:
at least one first input port each for receiving a respective input multiple wavelength optical signal;
for each first input port, an optical signal separator adapted to separate the input optical signal into at least two portions, and to output each portion to a respective first output port;
at least one second output port for outputting a respective output optical signal;
for each second output port, an optical signal combiner having at least two second input ports, the optical signal combiner adapted to combine optical signals received at the at least two second input ports;
at least one reconfigurable wavelength selective device, each wavelength selective device interconnecting wavelength selectively one of the first output ports to at least one of the second input ports.

2. The apparatus of claim 1 wherein each optical signal separator is selected from a group consisting of:
a signal splitter in which case each portion of a given input signal is a fraction of the input signal for all wavelengths;
a fixed band demultiplexer in which case the portions of a given input signal comprise non-overlapping wavelength subsets;
an optical interleaver.

3. The apparatus of claim 1 wherein each optical signal combiner is selected from a group consisting of:
a passive combiner;
a fixed band multiplexer; and
an optical de-interleaver.

4. The apparatus of claim 1 wherein for at least one first input port:
the optical signal separator comprises a first wavelength selective device adapted to produce said portions as non-overlapping sets of wavelengths, when present, in the input multiple wavelength optical signal;
the at least one second output port comprises at least two second output ports, and each optical signal combiner comprises a respective second wavelength selective device;
each said reconfigurable wavelength selective device is connected to a respective one of the plurality of first output ports and to a respective plurality of the second output ports via second input ports, each reconfigurable wavelength selective device being adapted to selectively route any wavelength received to any of the plurality of second output ports.

5. The apparatus of claim 4 wherein:
each non-overlapping subset of wavelengths is a contiguous subset of an overall set of wavelengths, the first wavelength selective device is a band demultiplexer, and each second wavelength selective device is a band multiplexer.

6. The apparatus of claim 4 wherein said at least one reconfigurable wavelength selective device comprises a single wavelength selective switch.

7. The apparatus of claim 4 wherein said at least one reconfigurable wavelength selective device comprises two wavelength selective switches.

8. The apparatus of claim 1 wherein for at least one optical signal separator, optical signal combiner pair:
the optical signal separator is a adapted to output a respective non-overlapping set of wavelengths, when present, in the input multiple wavelength optical signal to a respective first output port of the plurality of first output ports;
the optical signal separator and the optical signal combiner are interconnected with an optical interconnection between each first output port of the optical signal separator and a corresponding one of the second input ports of the optical signal combiner, wherein said at least one reconfigurable wavelength selective device comprises a wavelength adding device and/or a wavelength dropping device in at least one of the optical interconnections.

9. The apparatus of claim 8 wherein for at least one optical signal separator, optical signal combiner pair:
each non-overlapping subset of wavelengths is a contiguous subset of an overall set of wavelengths, the optical signal separator is a band demultiplexer, and the optical signal combiner is a band multiplexer.

10. The apparatus of claim 8 wherein for the at least one pair optical signal separator, optical signal combiner pair, the optical signal separator has two first output ports, and the optical signal combiner has two second input ports.

11. The apparatus according to claim 8 wherein at least one of the optical interconnections is a direct interconnection.

12. The apparatus according to claim 8 wherein at least two of the optical interconnections each comprises a respective wavelength adding device and/or a respective wavelength dropping device.

13. The apparatus of claim 12 further comprising:
at least one second optical signal combiner combining an output of the wavelength dropping device of two optical interconnections into a combined drop port.

14. The apparatus of claim 13 wherein the at least one second optical signal combiner is a passive combiner.

15. The apparatus of claim 13 wherein the at least one second optical signal combiner is a band multiplexer.

16. The apparatus of claim 12 wherein:
at least one second optical signal separator separating an input signal to two input ports of two add devices of two optical interconnections.

17. The apparatus of claim 16 wherein the at least one second optical signal separator is a signal splitter.

18. The apparatus of claim 16 wherein the at least one second optical signal separator is a band demultiplexer.

19. The apparatus of claim 12 further comprising:
at least one second optical signal combiner combining an output of the wavelength dropping device of two optical interconnections into a combined drop port;
at least one second optical separator separating an input signal to two input ports of two wavelength adding devices of two optical interconnections.

20. The apparatus of claim 19 further comprising a tunable laser connected to one of said second optical signal combiner.

21. The apparatus of claim 12 wherein there are two optical interconnections each having a respective wavelength adding device and a respective wavelength dropping device, each wavelength adding device has a plurality of add ports, and each wavelength dropping device has a plurality of drop ports, the apparatus further comprising:
for each of pair of drop ports comprising one port of each of said pluralities of drop ports, a respective second optical signal combiner combining outputs of the pair of drop ports into a combined drop port signal;
for each pair of add ports comprising one port of each of said pluralities of add ports, at least one second optical signal separator splitting an input signal to the two add ports.

22. The apparatus of claim 21 wherein each second optical signal combiner is a band multiplexer and each second optical signal separator is a band demultiplexer.

23. The apparatus of claim 21 wherein each second optical signal combiner is a passive combiner and each second optical signal separator is an optical signal splitter.

24. The apparatus of claim 8 wherein one of the optical interconnections is a direct interconnection, and one of the optical interconnections comprises a wavelength dropping device, the apparatus further comprising a passive coupling arrangement coupled to the output of the second wavelength selective device for wavelength adding.

25. The apparatus of claim 8 wherein for at least one optical signal separator, optical signal combiner pair, the wavelength separator is an optical interleaver and the wavelength combiner is an optical de-interleaver.

26. The apparatus of claim 25 wherein one of the optical interconnections is a direct connection between odd outputs of the interleaver and odd inputs of the optical de-interleaver, and the other of the optical interconnections comprises an add device and a drop device both operating on even wavelengths.

27. The apparatus of claim 25 wherein one of the optical interconnections is a direct connection between even outputs of the interleaver and even inputs of the optical de-interleaver, and the other of the optical interconnections comprises an add device and a drop device both operating on odd wavelengths.

28. The apparatus of claim 8 wherein for at least one optical signal separator, optical signal combiner pair:
the optical signal separator is an optical interleaver tunable to output even wavelengths to one first output port odd wavelengths to another first output port;
the optical signal combiner is an optical de-interleaver tunable to combine even wavelengths at one second input port and odd wavelengths at another second input port.

29. The apparatus of claim 28 wherein one of the optical interconnections is a direct connection between one first output of the interleaver and one first input of the optical de-interleaver, and the other of the optical interconnections comprises an add device tunable to add either even or odd wavelengths and/or a drop device tunable to add either even or odd wavelengths.

30. The apparatus of claim 25 wherein the interleaver and part of the wavelength adding device and or wavelength dropping device are integrated on a common waveguide substrate.

31. An apparatus comprising:
a full-band drop device having an input port, a through port and a first plurality of drop ports;
a full-band add device having an input port connected to the through port of the full-band device, and having a first plurality of add ports;
a reduced-band drop device having a second plurality of drop ports, and having an input port connected to one of said first plurality of drop ports;
a reduced-band add device having a second plurality of add ports and having an output port connected to one of said first plurality of add devices.

32. An apparatus comprising:
a first main optical path comprising a first wavelength adding device having a first plurality of add ports and a first wavelength dropping device having a first plurality of drop ports;
a second main optical path comprising a second wavelength adding device having a second plurality of add ports and a second wavelength dropping device having a second plurality of drop ports;
for each of pair of drop ports comprising one port of each of said pluralities of drop ports, a respective optical signal combiner combining outputs of the pair of drop ports into a combined drop port signal;
for each pair of add ports comprising one port of each of said pluralities of add ports, at least one optical separator separating an input signal to the two add ports.

33. The apparatus of claim 32 wherein the first add device and the first drop device operate on a first set of wavelengths, and the second add device and the second drop device operate on a second set of wavelengths that does not overlap with said first set of wavelengths.

34. The apparatus of claim 33 wherein the first set of wavelengths is a contiguous set and the second set of wavelengths is a contiguous set.

35. The apparatus of claim 33 further comprising at least a tunable laser attached to the at least one optical signal separator separating a laser output into input signals for two add ports.

36. An apparatus comprising:
a plurality M of port pairs each comprising an input port and an output port;
for each input port, an optical signal separator splitting an input optical signal into at least two portions;
for each output port, an optical signal combiner for combining optical signals received at inputs to the optical signal combiner;
a plurality of interconnections and wavelength selective switches between outputs of optical signal separators and inputs of the optical signal combiners.

37. The apparatus of claim 36 wherein each optical signal separator is a band de-multiplexer.

38. The apparatus of claim 36 wherein each optical signal separator is a passive splitter.

39. The apparatus of claim 37 further comprising passive drop ports on at least one of the passive splitters.

40. The apparatus of claim 37 further comprising a fixed wavelength de-multiplexer connected to drop wavelengths at the at least one passive splitter.

41. The apparatus of claim 36 wherein each optical signal separator is a passive splitter and each optical signal combiner is a band multiplexer.

42. An apparatus according to claim 36 wherein the plurality of interconnections and wavelength selective switches between outputs of optical signal separators and inputs of optical signal combiners comprise:
interconnections and wavelength selective switches to implement a degree N cross connect in at least one of the subsets, where N<=M.

43. An apparatus according to claim 42 wherein the plurality of interconnections and wavelength selective switches between outputs of optical signal separators and inputs of optical signal combiners comprise: interconnections and wavelength selective switches to implement a degree N′ cross connect in another of the subsets, where N′21 =M.

44. An apparatus according to claim 37 wherein the plurality of interconnections and wavelength selective switches between outputs of optical signal separators and inputs of optical signal combiners comprise:
at least one direct connection between an optical signal separator and an optical signal combiner such that one of the subsets is directly and statically routed between one of the input ports and one of the output ports.

45. A method comprising:
receiving at least one input multiple wavelength optical signal;
for each input multiple wavelength optical signal, separating the input optical signal into at least two portions;
outputting at least one output optical signal as a combination of at least two optical signals;
wavelength selectively switching at least one of the portions to produce at least one of the optical signals to be combined in the output optical signals.

46. The method of claim 45 wherein separating consists of one of:
signal splitting;
fixed band demultiplexing;
optical interleaving.

47. The method of claim 45 wherein combining consists of one of:
passively combining;
fixed band multiplexing; and
optical de-interleaving.

48. The method of claim 45 wherein for at least one input signal:
separating produces said portions as non-overlapping sets of wavelengths, when present, in the input multiple wavelength optical signal;
the output optical signal comprises at least two output optical signals, and combining comprises performing wavelength selective combining;
wavelength selectively switching comprises:
for at least one of the portions, performing a WSS function individually on the portion to produce a plurality of WSS outputs, a respective WSS output being combined in each optical output signal.

49. The apparatus of claim 1 wherein the reconfigurable wavelength selective device is a cyclical wavelength selective device.
